(19) United States
(12) Patent Application Publication
(10) Pub. No.: US 2019/0354945 A1
(43) Pub. Date: Nov. 21, 2019

(54) REAL-TIME BUYING, SELLING, AND/OR TRADING BLOCKCHAIN-BASED GOODS USING TRADITIONAL CURRENCY

(71) Applicant: Rare Bits, Inc., San Francisco, CA (US)

(72) Inventors: Amitt Mahajan, San Francisco, CA (US); Payom Dousti, San Francisco, CA (US)

(21) Appl. No.: 16/413,533

(22) Filed: May 15, 2019

Related U.S. Application Data
(60) Provisional application No. 62/672,365, filed on May 16, 2018.

(51) Int. Cl. G06Q 20/06; G06Q 40/04; G06Q 20/38

(52) U.S. Cl. CPC G06Q 20/065; G06Q 20/381; G06Q 40/04

(57) ABSTRACT

A fiat to blockchain-based items/goods system is disclosed, which can be used by a user to purchase blockchain-based goods using traditional payment methods (fiat currency transactions using, e.g., credit card, debit card, bank account, PayPal account, Apple Pay, Google Wallet/Google Pay, etc.) without first requiring the user to create a blockchain wallet and fund it via an account with a digital currency exchange.

### CROSS-REFERENCE TO RELATED APPLICATION

This application claims the benefit of the inventor's U.S. Provisional Patent Application No. 62/672,365, filed May 16, 2018, entitled “REAL-TIME BUYING, SELLING, AND/OR TRADING BLOCKCHAIN-BASED GOODS USING TRADITIONAL CURRENCY” (attorney docket number 125374-8001.US00), which is incorporated by reference in its entirety.

### BACKGROUND

The Bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key of the new owner, is digitally signed by the owner with the owner's private key to transfer ownership to the new owner as represented by the new owner public key. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the Bitcoin system is pseudo-anonymous.

To ensure that a previous owner of a bitcoin did not double-spend the bitcoin (i.e., transfer ownership of the same bitcoin to two parties), the Bitcoin system maintains a distributed ledger of transactions. With the distributed ledger, a ledger of all the transactions for a bitcoin is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The Bitcoin system also implements techniques to ensure that each node will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The Bitcoin system also implements techniques to ensure that it would be infeasible to change a transaction and regenerate the blockchain by employing a computationally expensive technique to generate a nonce that is added to the block when it is created. A Bitcoin ledger is sometimes referred to as an Unspent Transaction Output (UXTO) set because it tracks the output of all transactions that have not yet been spent.

Although the Bitcoin system has been very successful, it is limited to transactions in bitcoins or other cryptocurrencies. Efforts are currently underway to use blockchains to support transactions of any type, such as those relating to the sale of vehicles, sale of financial derivatives, sale of collectible goods, sale of stock, payments on contracts, and so on. Such transactions use identity tokens, which are also referred to as digital bearer bonds, to uniquely identify something that can be owned or can own other things. An identity token for a physical or digital asset is generated using a cryptographic one-way hash of information that uniquely identifies the asset. Tokens also have an owner that uses an additional public/private key pair. The owner public key is set as the token owner identity and when performing actions against tokens, ownership proof is established by providing a signature generated by the owner private key and validated against the public key listed as the owner of the token. A person can be uniquely identified, for example, using a combination of a user name, social security number, and biometric (e.g., fingerprint). A product (e.g., refrigerator) can be uniquely identified, for example, using the name of its manufacturer and its serial number. The identity tokens for each would be a cryptographic one-way hash of such combinations. The identity token for an entity (e.g., person or company) may be the public key of a public/private key pair, where the private key is held by the entity. Identity tokens can be used to identify people, institutions, commodities, contracts, computer code, equities, derivatives, bonds, insurance, loans, documents, and so on. Identity tokens can also be used to identify collections of assets. An identity token for a collection may be a cryptographic one-way hash of the digital tokens of the assets in the collection. The creation of an identity token for an asset in a blockchain establishes provenance of the asset, and the identity token can be used in transactions (e.g., buying, selling, insuring) of the asset stored in a blockchain, creating a full audit trail of the transactions.

To record a simple transaction in a blockchain, each party and asset involved with the transaction needs an account that is identified by a digital token. For example, when one person wants to transfer a car to another person, the current owner and next owner create accounts, and the current owner also creates an account that is uniquely identified by its vehicle identification number. The account for the car identifies the current owner. The current owner creates a transaction against the account for the car that indicates that the transaction is a transfer of ownership transfer, indicates the public keys (i.e., identity tokens) of the current owner and the next owner, and indicates the identity token of the car. The transaction is signed by the private key of the current owner and the transaction is evidence that the next owner is now the current owner.

To enable more complex transactions than Bitcoin can support, some systems use “smart contracts.” A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain. For example, a smart contract may support the sale of an asset. The inputs to a smart contract to sell a car may be the identity tokens of the seller, the buyer, and the car, and the sale price in U.S. dollars. The computer code ensures that the seller is the current owner of the car and that the buyer has sufficient funds in their account. The computer code then records a transaction that transfers the ownership of the car to the buyer and a transaction that transfers the sale price from the buyer's account to the seller's account. If the seller's account is in U.S. dollars and the buyer's account is in Canadian dollars, the computer code may retrieve a currency exchange rate, determine how many Canadian dollars the seller's account should be debited, and record the exchange rate. If either transaction is not successful, neither transaction is recorded.

When a message is sent to a smart contract to record a transaction, the message is sent to each node that maintains a replica of the blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide on which transactions to keep and which transactions to discard. Although the execution of the computer code at each node helps ensure the authenticity of the blockchain, it requires large amounts of computer resources to support such redundant execution of the computer code.

The term “contract” has been used to describe the computer code of a contract under the UXTO model of Bitcoin and the computer code of the “smart contracts” model of the Ethereum platform. The “contracts” under these models are, however, different. In the UXTO model, the distributed ledger is a set of immutable rows keyed by (hash: output index) values. The “hash” is a hash of the transaction that generated the output represented by the row, and the “output index” identifies which one of the possibly many outputs of the transaction that the row represents. A UXTO contract is deterministic and performs no processing other than validating the inputs to the transaction. In the “smart contract” model, the computer code of the smart contract is an instantiation of the computer code that is maintained by every node that stores the blockchain. A “smart contract” can perform virtually any type of processing, such as receiving messages, sending messages, accessing external databases, and so on.

### BRIEF DESCRIPTION OF THE DRAWINGS

FIG. 1 is a block diagram showing some of the components typically incorporated in at least some of the computer systems and other devices on which the fiat to blockchain-based items system operates.

FIG. 2 illustrates an example of a communications environment in which some embodiments of the fiat to blockchain-based items system can be utilized.

FIGS. 3A-3C are flow diagrams showing processes performed by the fiat to blockchain-based items system in some embodiments for purchasing blockchain-based goods using traditional payment means.

FIG. 4 is a system diagram illustrating an example of a computing environment in which the fiat to blockchain-based items system operates in some embodiments.

FIGS. 5A-5B are display diagrams illustrating example user interfaces for listing a blockchain-based item for sale according to various implementations.

FIG. 6A is a display diagram illustrating an example user interface for purchasing a blockchain-based item according to various implementations.

FIG. 6B is a display diagram illustrating an example user interface for transferring a blockchain-based item to a buyer's electronic wallet according to various implementations.

FIG. 7 is a display diagram illustrating an example user interface displaying transaction history of a blockchain-based item according to various implementations.

### DETAILED DESCRIPTION

Traditional processes for purchasing blockchain-based items (also called crypto-goods) (e.g., digital items, tickets, deeds, etc.) using cryptocurrency are convoluted and complicated for a typical end-user. These blockchain-based items, their owners, and their pricing data are stored on a blockchain and can be interacted with using, for example, a smart contract. The smart contract allows listing of goods, purchasing of listed goods, and the transfer of goods. All of these transactions occur “on-chain” and are denominated in a cryptocurrency. Currently, a user who wishes to purchase physical or digital items using blockchain is first required to obtain an account with a digital currency exchange (e.g., Gemini, Coinbase, Kraken, etc.). The user then verifies the account by uploading a wide variety of documents providing the identity of the user. Verification of the uploaded information takes a few days. Once the account is verified, the user deposits regular (or fiat) currency (e.g., U.S. dollars) into the exchange. Depending on the source banking institution and the wire transfer, this step typically takes 3-5 business days. Once the user receives the USD in his/her exchange account, the user can use it to purchase cryptocurrency (e.g., bitcoin, ether (“ETH”), etc.). After purchasing the cryptocurrency, the user obtains a blockchain wallet (e.g., an Ethereum wallet). After acquiring the blockchain wallet, the user funds the blockchain wallet with the purchased cryptocurrency. The user is then able to execute a purchase transaction (purchase blockchain-based items) using the cryptocurrency in the blockchain wallet. As a result, traditional processes tend to take a long period of time to complete and introduce a lot of latency in the process for a user to acquire blockchain-based items.

Accordingly, the inventors have conceived and reduced to practice a software and/or hardware fiat to blockchain-based items/goods system (hereinafter called a fiat to blockchain-based items system) that can be used by a user to purchase blockchain-based goods using traditional payment methods (fiat currency) (e.g., credit card, debit card, bank account, PayPal account, Apple Pay, Google Wallet/Google Pay, etc.) without first requiring the user to create a blockchain wallet and fund it via an account with a digital currency exchange. In this manner, the fiat to blockchain-based items system provides an experience similar to that provided by typical e-commerce platforms for physical goods purchased using traditional payment methods. The fiat to blockchain-based items system reduces the friction of purchasing blockchain-based assets for non-technical users; thus, hastening the adoption of blockchain-based assets exchange for users.

The fiat to blockchain-based items system enables a user to buy, sell, trade, and/or acquire rights in blockchain-based goods (e.g., via a web service) using traditional payment methods using fiat currency (e.g., pay in U.S. dollars using a credit card). Examples of rights in a blockchain-based good include a right to own the blockchain-based item by the buyer, a right to trade the blockchain-based item by the buyer with another user, a right to transfer ownership of the blockchain-based item to another user, a right to grant one or more rights to another user in the blockchain-based item, a right to license one or more rights to another user in the blockchain-based item, and so on. If the user provides a cryptocurrency address (e.g., an address associated with a digital currency exchange/blockchain wallet), the fiat to blockchain-based items system (e.g., via a web service) uses the provided cryptocurrency address for delivery of the selected blockchain-based good.

The fiat to blockchain-based items system enables a user to seamlessly transition from fiat currency to a smart contract reflecting the transaction (e.g., buy, sell, and/or trade). In several embodiments, the fiat to blockchain-based items system enables a user to select among several traditional payment methods using different fiat currency options to perform smart contract transactions (e.g., purchase a blockchain-based good). Otherwise, the fiat to blockchain-based items system provisions a new wallet (on-chain or off-chain) for the user to hold the blockchain-based good in. In several embodiments, the fiat to blockchain-based items system in real time uses a pool of stored cryptocurrency (e.g., a cryptocurrency reserve system) to execute a smart contract function for the user to purchase a given blockchain-based good. In several embodiments, the fiat to blockchain-based items system maintains separate pools of cryptocurrencies for different blockchain platforms (e.g., Ethereum pools, bitcoin pools, EOS pools, etc.), buyer types (e.g., beginner buyers, intermediate buyers, advanced buyers), buyer location (geography-dependent), selling vendor location, selling user type (small sellers, medium sellers, large sellers), good type, good location, amount of transaction, other factors. In several embodiments, pool characteristics (e.g., number of pools, types of pools, amount per pool, availability of pools, etc.) are based on one or more factors such as the blockchain platform, risk involved in certain types of transactions, risk profile of buyer, risk profile of seller, risk profile of cryptocurrency account of the buyer, security factors, volatility of marketplace, historical transactions, and so on. For example, the system uses an average or peak of previous sales numbers to determine the amount of currency needed in a reserve pool.

In several embodiments, instead of using a cryptocurrency reserve system, the fiat to blockchain-based items system purchases cryptocurrency directly from a digital currency exchange using the traditional payment methods provided by the user. The fiat to blockchain-based items system can pre-purchase blockchain-based goods and hold them directly in its own account/wallet instead of using a smart contract. The fiat to blockchain-based items system pays for the blockchain-based goods using its own cryptocurrency wallet(s) and then re-sells the goods on its own marketplace platform where users can then purchase the blockchain-based goods using traditional payment methods. When a buyer purchases a pre-purchased blockchain-based good, the fiat to blockchain-based items system verifies the traditional payment (e.g., U.S. dollar payment using a credit card) and transfers the pre-purchased blockchain-based good from the system's own account/wallet to the buyer's wallet. This allows guaranteed delivery of goods.

In the following description, for the purposes of explanation, numerous specific details are set forth in order to provide a thorough understanding of embodiments of the present technology. It will be apparent, however, to one skilled in the art that embodiments of the present technology may be practiced without some of these specific details. While, for convenience, embodiments of the present technology are described with reference to passive privacy breach notifications, embodiments of the present technology are equally applicable, creating additional notifications in response to various triggering events. The terms goods and items are used interchangeably herein and are used to denote individual or group of articles/units that can be transacted over a blockchain. While the discussion below discusses mechanisms by which a user (buyer) can buy/purchase blockchain-based goods, it will be readily understood that similar mechanisms apply to other types of transactions (e.g., sell, trade, and/or acquire rights) in the blockchain-based goods.

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CDROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in several embodiments,” “in some embodiments,” “according to several embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

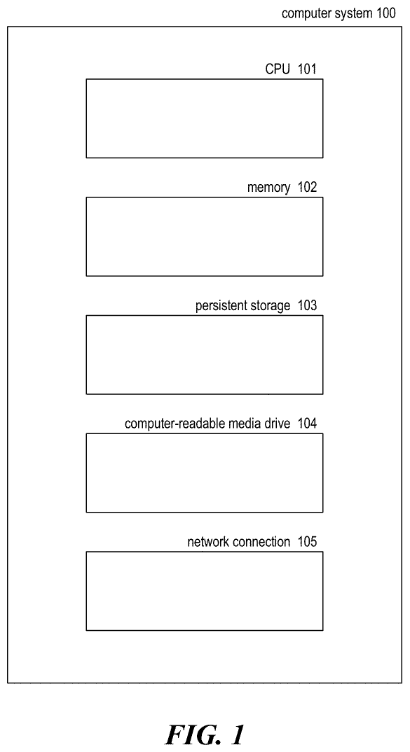

FIG. 1 is a block diagram showing some of the components typically incorporated in at least some of the computer systems and other devices on which the fiat to blockchain-based items system operates. In various embodiments, these computer systems and other devices 100 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (CPU) 101 for executing computer programs; a computer memory 102 for storing programs and data while they are being used, including the fiat to blockchain-based items system and associated data; an operating system including a kernel and device drivers; a persistent storage device 103, such as a hard drive or flash drive for persistently storing programs and data; a computer-readable media drive 104 that are tangible storage means that do not include a transitory, propagating signal, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. The computing systems can include a secure cryptoprocessor as part of a central processing unit for generating and securely storing keys and for encrypting and decrypting data using the keys. While computer systems configured as described above are typically used to support the operation of the fiat to blockchain-based items system, those skilled in the art will appreciate that the fiat to blockchain-based items system can be implemented using devices of various types and configurations, and having various components.

The fiat to blockchain-based items system can be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules can be combined or distributed as desired in various examples. Aspects of the fiat to blockchain-based items system can be implemented in hardware using, for example, an application-specific integrated circuit (ASIC) or field programmable gate array (FPGA).

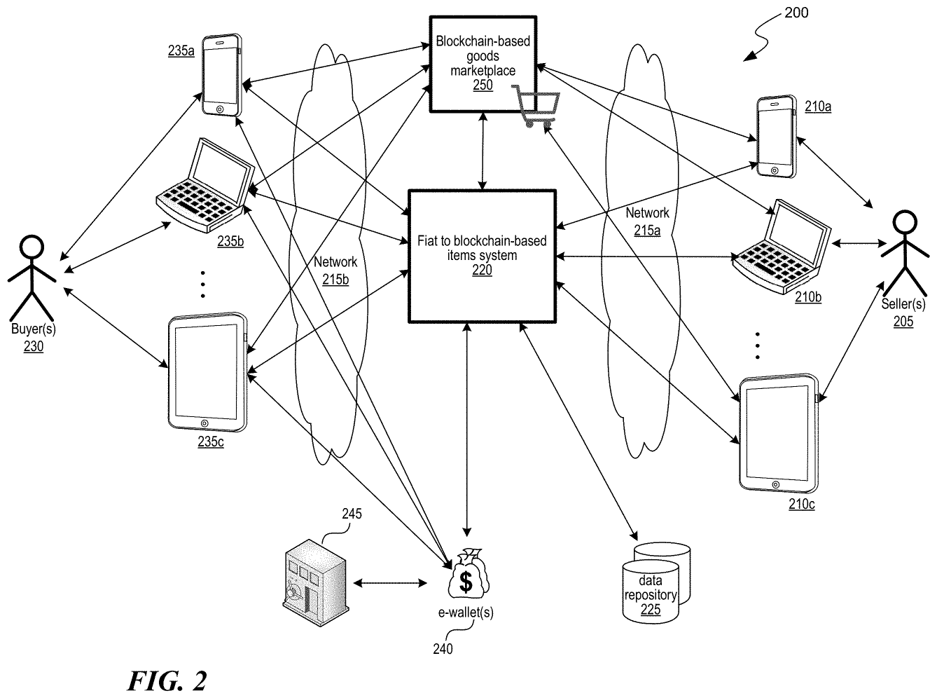

FIG. 2 illustrates an example of a communications environment 200 in which some embodiments of the fiat to blockchain-based items system can be utilized. In various embodiments, environment 200 comprises a fiat to blockchain-based items system 220. Seller(s) 205 can use various electronic devices (e.g., mobile device 210a, laptop/PC 210b, tablet 210c, etc.) to list one or more goods/assets for sale on the blockchain. In several embodiments, seller(s) 205 can list the blockchain goods/assets for sale directly at a blockchain-based goods marketplace 250, a blockchain smart contract platform based on, for example, Ethereum, and so on via a communications network 215a, such as a Local Area Network (LAN), Wide Area Network (WAN), the Internet, and the like. Seller(s) 205 can also communicate with a fiat to blockchain-based items system 220 via communications network 215a (e.g., using web services) regarding goods/assets listed for sale. In several embodiments, the blockchain-based goods marketplace 250 is integrated with the fiat to blockchain-based items system 220 (e.g., as an integrated e-commerce platform for blockchain-based goods/assets).

Buyer(s) 230 can use various electronic devices (e.g., mobile device 235a, laptop/PC 235b, tablet 235c, etc.) to browse, search for, and purchase one or more goods/assets listed for sale on the blockchain. For example, buyer(s) 230 can access an integrated e-commerce platform for blockchain-based goods/assets via communications network 215b (e.g., using web services). Buyer(s) 230 and/or the fiat to blockchain-based items system 220 can also communicate with one or more blockchain wallets 240 (e.g., using a cryptocurrency account), which can be in communication with a cryptocurrency provider 245, to provide payment for the purchased blockchain-based goods/assets. The fiat to blockchain-based items system 220 can also communicate with one or more data storage repositories 225 to store and/or access information about one or more goods/assets listed for sale (e.g., good/asset identifier, description, selling price, seller, quantity, auction price, auction structure, shipping information, etc.), seller(s) (e.g., seller identifier, name, address, contact information, ratings, etc.), buyer(s) (e.g., buyer identifier, name, address, contact information, ratings, cryptocurrency address(es), etc.), and so on.

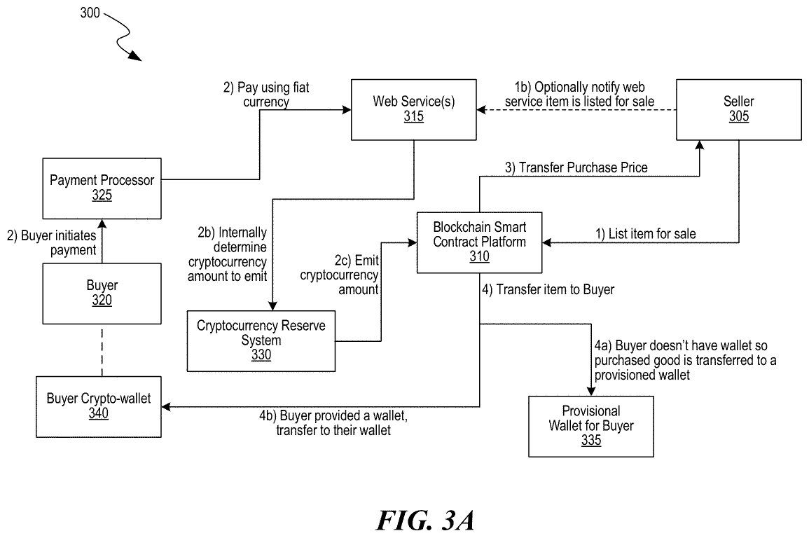

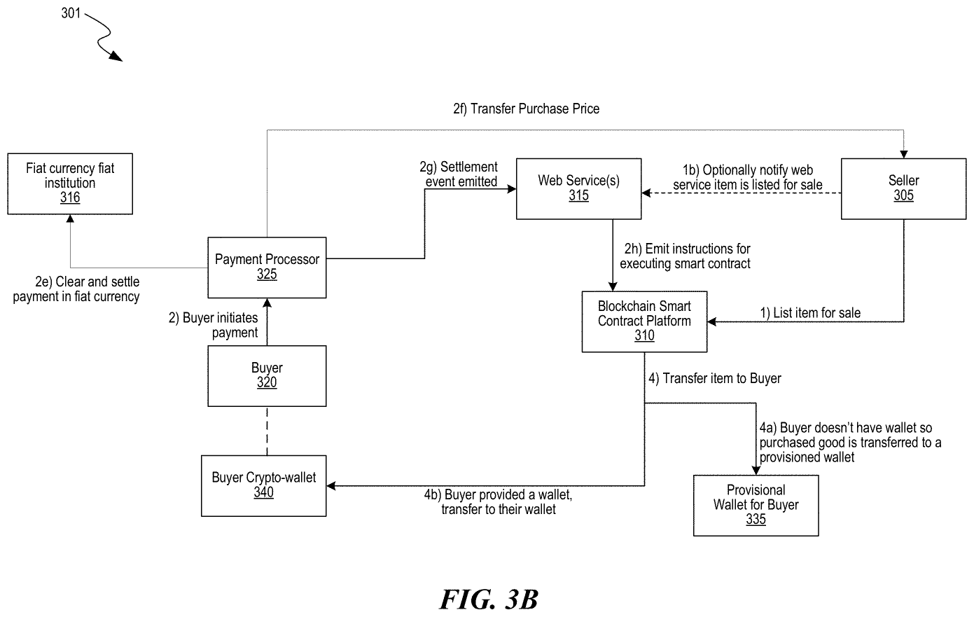

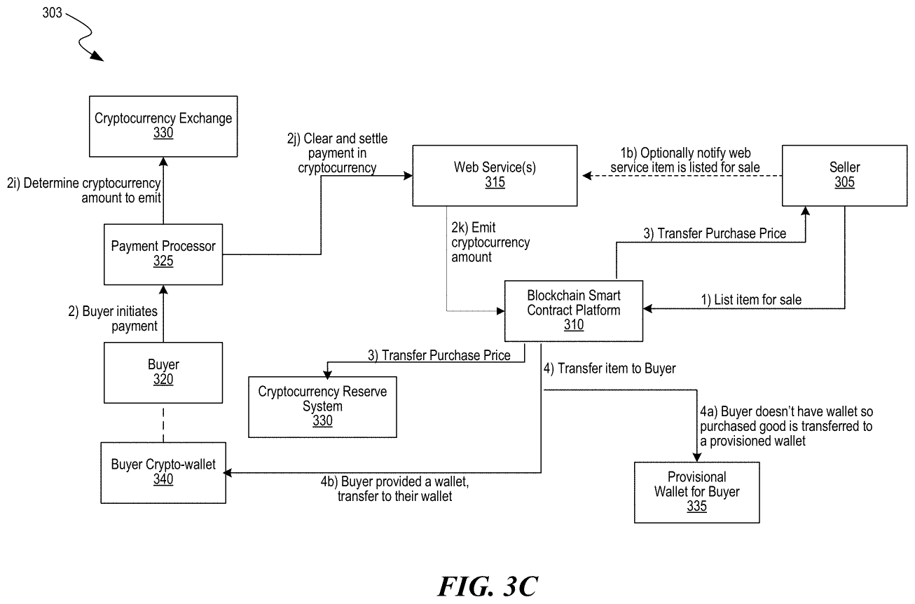

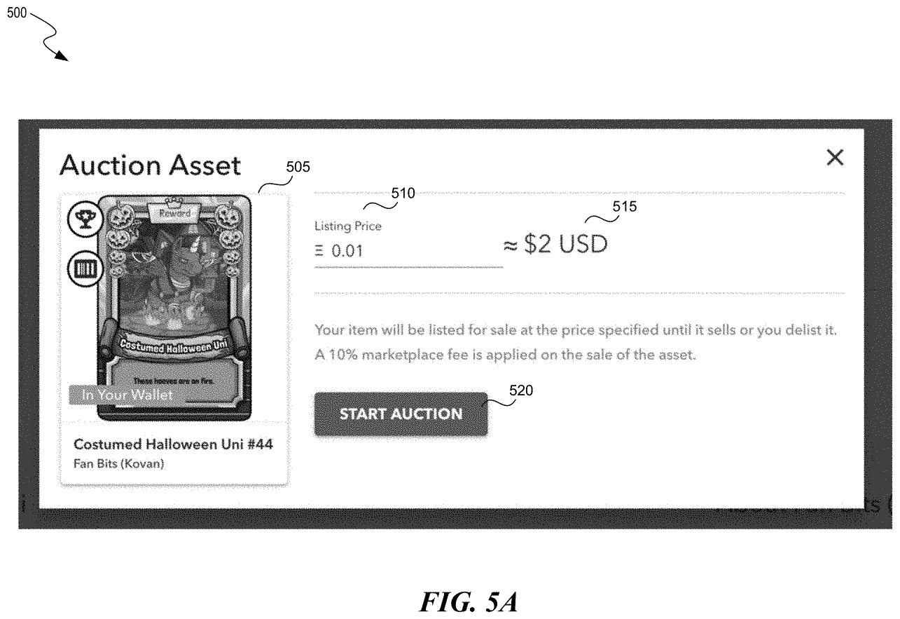

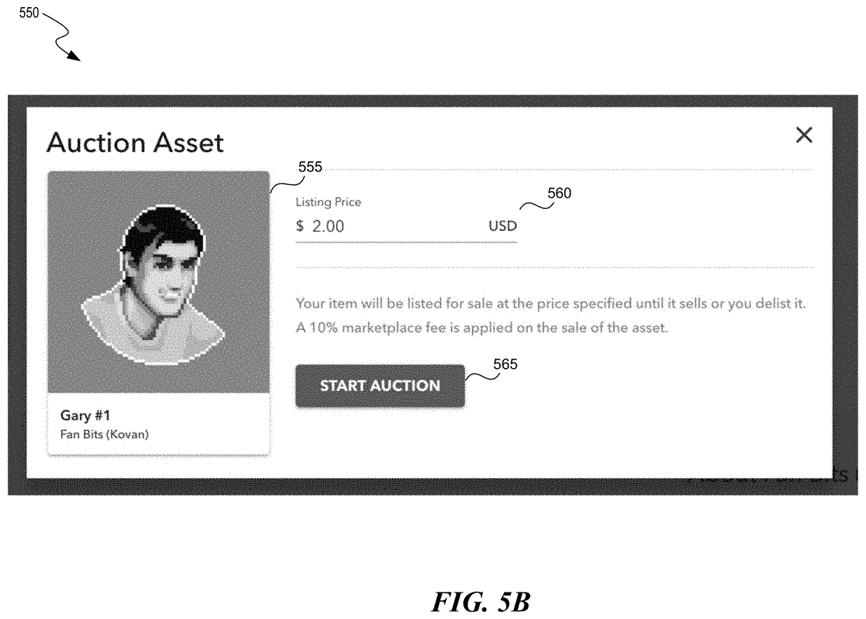

FIG. 3A is a flow diagram showing a process 300 performed by the fiat to blockchain-based items system in some embodiments for purchasing blockchain-based goods using traditional payment means. A seller 305 can list a good/asset (e.g., a blockchain-based good/asset) for sale with a blockchain smart contract platform 310 (e.g., the blockchain-based goods marketplace 250 in FIG. 2) by providing details about the good/asset (e.g., identifier, name, description, image, price, auction price, auction type, etc.) (act (1)). The price for the blockchain-based item can be provided in fiat currency (e.g., U.S. dollars, CAD dollars, etc.) or cryptocurrency (e.g., ETH, bitcoin, etc.), or both. FIG. 5A is a display diagram illustrating an example user interface 500 for listing a blockchain-based item for sale in terms of cryptocurrency. When an item is listed for sale, the fiat to blockchain-based items system can display the following information: description (and/or image) 505, listing price in cryptocurrency 510, listing price in fiat currency 515, and so on. The user interface 500 provides an option to the seller to activate the listing by, for example, starting an auction for the item (using control 520). FIG. 5B is a display diagram illustrating an example user interface 550 for listing a blockchain-based item for sale in terms of fiat currency. When an item is listed for sale, the fiat to blockchain-based items system can display the following information: description (and/or image) 555, listing price in fiat currency 560, and so on. The user interface 550 provides an option to the seller to activate the listing by, for example, starting an auction for the item (using control 565).

The fiat to blockchain-based items system creates a good/asset identifier for the blockchain-based item when the item is created on the blockchain and uniquely identifies the good/asset. In instances where the goods have unique identifiers associated with them (e.g., VIN numbers for vehicles), those identifiers can be created on or added by the blockchain. In several embodiments the price of the good/asset is selected based on one or more of the following factors: quantity, availability, inventory, current demand, past demand, anticipated future demand, previous pricing data, pricing data of other similar goods/assets, whether the good/asset is pre-purchased by the system, and so on. The good/asset can be associated with one or more properties based on its type. For example, for a good/asset of type “games,” the system can store game-specific properties. The system can also access third party data sources, such as final prices for similar goods on online auction sites.

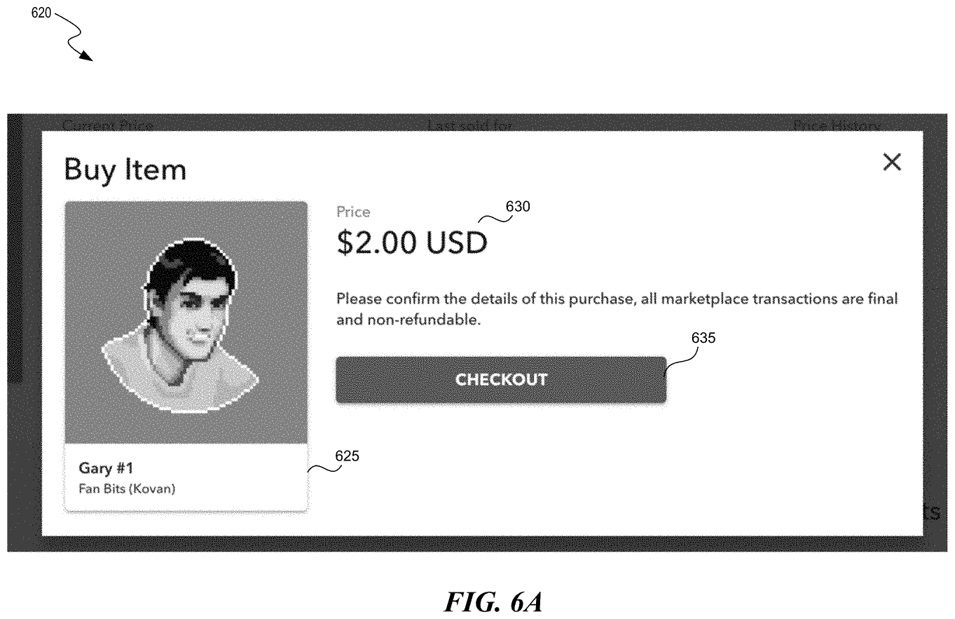

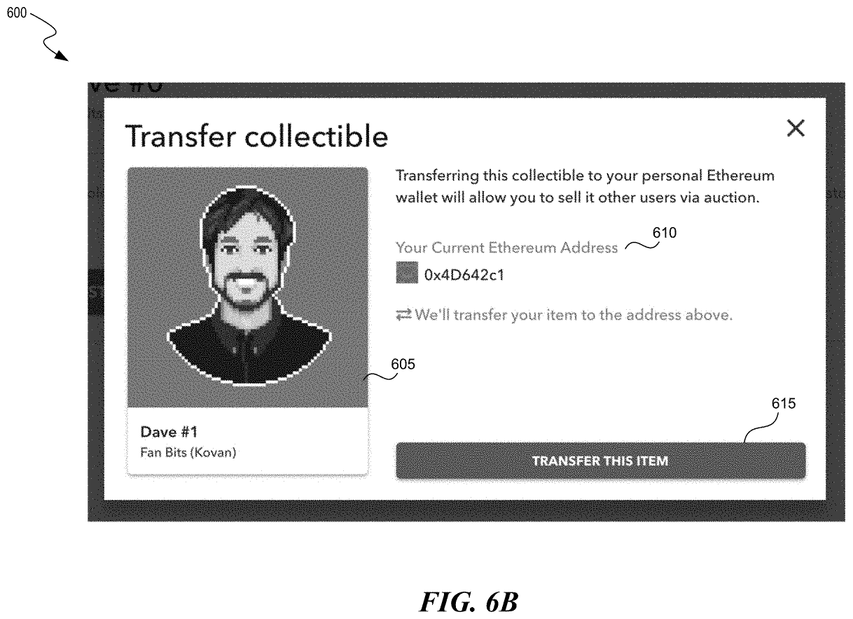

In several embodiments, seller 305 can also notify a fiat to blockchain-based items system (via, for example, web services 315) that the good/asset is listed for sale (act 1b). The blockchain smart contract platform 310 can be integrated and/or associated with the fiat to blockchain-based items system web service 315. A buyer 320 who wishes to purchase the listed good/asset can initiate payment for a selected good/asset, via a payment processor 325 (for example by selecting a traditional payment method such as credit card, debit card, PayPal, wire transfer, etc.), at the fiat to blockchain-based items system web service 315 (act 2). The price for the good/asset can be listed in the traditional currency (fiat). For example, a good/asset can be listed for sale for USD 100. The fiat to blockchain-based items system 220 can determine the corresponding price of the good/asset in cryptocurrency (e.g., bitcoin, ETH, etc.) using, for example, an exchange rate. FIG. 6A is a display diagram illustrating an example user interface 620 for purchasing a blockchain-based item 625 listed at a particular price 630. The buyer can activate control 635 to purchase item 625 at the purchase price 630. According to terms of the listing, the purchase price can be equal to, greater than, or less than the listing price.

In several embodiments, at act 2b, the fiat to blockchain-based items system (via, for example, web services 315) communicates with a cryptocurrency reserve system 330 to determine an amount of cryptocurrency to emit for the purchase of the good/asset. The determined amount of cryptocurrency can be a combination of one or more of the following: the computed corresponding price of the good/asset in cryptocurrency, a computed amount of cryptocurrency for operational costs, a computed fees amount for purchasing the good/asset, an agreed upon or pre-determined exchange rate, absolute price in given currencies, and so on. In several embodiments, instead of using a cryptocurrency reserve system 330, the fiat to blockchain-based items system purchases cryptocurrency directly from a cryptocurrency exchange using the provided traditional currency. The cryptocurrency reserve system 330 holds previously provisioned/purchased cryptocurrency, one or more pools of cryptocurrencies, and so on. At act 2c, the cryptocurrency reserve system 330 emits the computed cryptocurrency amount to the blockchain smart contract platform 310.

In several embodiments, when the buyer 320 provides a cryptocurrency address (e.g., associated with a blockchain wallet), the fiat to blockchain-based items system (via, for example, web services 315) communicates with the corresponding blockchain wallet to emit a part of the commensurate cryptocurrency amount from the buyer's blockchain wallet to pay for the selected good/asset and execute a smart contract function with the blockchain smart contract platform 310. For example, at act 2c, the blockchain smart contract platform 310 receives a first part of the payment for the purchased good/asset from the cryptocurrency reserve system 330 and a second part of the payment form the buyer's blockchain wallet.

Once the cryptocurrency amount is emitted to the blockchain smart contract platform 310, the blockchain smart contract platform 310 then transfers the purchase price to the seller 305 (act 3). For example, the blockchain smart contract platform 310 executes a smart contract function to reflect the buyer's purchase of the selected good/asset and the transfer of the purchase price to the seller. In several embodiments, the blockchain smart contract platform 310 communicates over a highly secure channel with a third-party actor to execute the smart contract function for the purchased good/asset. Based on one or more preferences of the seller, the blockchain smart contract platform 310 can transfer the purchase price in the form of one or more of: cryptocurrencies, fiat currencies, points, mileage, and so on. For example, a default preference of the seller can be to receive the entire purchase price in the form of ETH. An alternate preference of the seller can be to receive a portion of the purchase price (e.g., 50%) in the form of ETH and the remaining portion in the form of US Dollars.

The purchased good/asset is then transferred to the buyer (act 4). For example, by default, when the smart contract is executed, the blockchain smart contract platform 310 transfers the purchased good/asset to the buyer's blockchain wallet 340 (act 4b). In several embodiments, when the buyer does not provide a cryptocurrency address (e.g., an address associated with a digital currency exchange/blockchain wallet), the blockchain smart contract platform 310 can provision a wallet for the buyer 335 so that the purchased good/asset can be transferred to it (act 4a). For example, the blockchain smart contract platform 310 can set up a wallet for the buyer 335 directly with a digital currency exchange (e.g., Ethereum) and associate it with a user identifier (e.g., email address, telephone number, personally identifiable information (PII) number, etc.). As another example, the blockchain smart contract platform 310 can use a third-party service (e.g., BitGo) to set up a wallet (e.g., a “multiple-signature” account) for the buyer 335. In some embodiments, the system mints the blockchain-based item at the time of transfer to the buyer.

FIG. 3B is a flow diagram showing a process 301 performed by the fiat to blockchain-based items system in some embodiments for purchasing blockchain-based goods using a credit card purchase transaction via strip integration (fiat currency settlement). One of ordinary skill in the art would understand that several of the actors and operations illustrated in FIG. 3B that are similar to those illustrated in FIG. 3A, perform functions similar to those described above in reference to FIG. 3A. Their description will not be repeated here. Process 301 begins at act 2 when the buyer initiates payment (for example, swipes a credit card at an end terminal, such as at a website that sells blockchain-based goods/assets). The purchase transaction (including details of the purchase record, such as buyer's name, identifier, credit card number, credit card company, expiration date, Credit card Validation Value (CVV), billing address, and so on) are forwarded to a payment processor 325. At act 2e, the payment processor 325 clears and settles payment in fiat currency with one or more fiat currency financial institutions 316 (such as banking institutions, credit card companies, and so on). The blockchain smart contract platform 310 can have an account with one of the fiat currency financial institutions 316 such that when the payment is cleared and settled, a commensurate payment amount (for example, commensurate to a royalty schedule) is transferred to the blockchain smart contract platform's bank account. Once the payment is cleared and settled, the payment processor 325, at act 2f, can transfer a portion (or all) of the purchase price to the seller 305 (for example, by crediting the seller's account with a fiat currency financial institution 316). According to terms of the listing, the purchase price can be equal to, greater than, or less than the listing price.

After the payment is cleared and settled, the payment processor 325 emits a settlement event to the web services 315 (act 2g). When the web services 315 receives the settlement event, at act 2h, it emits instructions to the blockchain smart contract platform 310 to execute a smart contract corresponding to the purchase of the good/asset by the buyer from the seller. In several embodiments, as part of executing the smart contract, a nominal amount of cryptocurrency is expended to support the execution. At act 4, the purchased good/asset is transferred to the buyer, as discussed in detail above.

FIG. 3C is a flow diagram showing a process 303 performed by the fiat to blockchain-based items system in some embodiments for purchasing blockchain-based goods using a credit card purchase transaction via simplex integration (cryptocurrency settlement). One of ordinary skill in the art would understand that several of the actors and operations illustrated in FIG. 3C that are similar to those illustrated in FIG. 3A, perform functions similar to those described above in reference to FIG. 3A. Their description will not be repeated here. Process 303 begins at act 2 when the buyer initiates a purchase transaction (for example, swipes a credit card at an end terminal). The purchase transaction (including details of the purchase record, such as buyer's name, identifier, credit card number, credit card company, expiration date, CVV, billing address, and so on) are forwarded to a payment processor 325. At act 2i, the payment processor 325 determines a corresponding purchase price in cryptocurrency to emit for the purchase of the asset/good. For example, based on the current market rate, the payment processor 325 computes the purchase price in a selected cryptocurrency.

At act 2j, the payment processor 325 clears and settles the computed purchase price amount, in the selected cryptocurrency (for example, the cryptocurrency amount), with the web services 315. After the payment is cleared and settled, at act 2k, the web services 315 emits the computed purchase price amount to the blockchain smart contract platform 310. In several embodiments, the blockchain smart contract platform 310 can execute a smart contract corresponding to the purchase of the good/asset by the buyer from the seller. As part of executing the smart contract, a nominal amount of cryptocurrency can be expended to support the execution. At act 3, the blockchain smart contract platform 310 delivers all or a portion of the computed purchase price amount to the seller 305 (e.g., seller's cryptocurrency wallet), the cryptocurrency reserve system 330 (for example, as fees), or both. At act 4, the purchased good/asset is transferred to the buyer, as discussed in detail above.

In several embodiments, the fiat to blockchain-based items system 315 pre-purchases goods/assets from sellers and holds them directly in its own wallet(s) instead of using a smart contract. The fiat to blockchain-based items system can also create/generate/mint its own goods/assets and list them for sale. When a buyer 320 purchases a good/asset owned by the blockchain smart contract platform 310, the blockchain smart contract platform 310 verifies the payment (using traditional payment means) and transfers the purchased good/asset from the wallet of the blockchain smart contract platform 310 to a wallet of the buyer (or a provisional wallet of the buyer when the buyer has not provided a cryptocurrency address). For auction-type transactions, the fiat to blockchain-based items system 315 can determine and/or maintain a “limit-order” where users can place their orders before the price reaches a certain point (for descending price auctions), after which the fiat to blockchain-based items system 315 automatically executes the transaction on behalf of the winning user via the previously set smart contract. Alternatively, or additionally, the fiat to blockchain-based items system 315 can perform an auction bidding process for the blockchain-based good/asset off-chain and then execute the actual swap between the buyer and seller on-chain.

The fiat to blockchain-based items system enables a buyer to purchase the blockchain-based item on “credit,” based on collateral or a trust score of their account. For example, a buyer can purchase the item (and the system will use one of its reserve cryptocurrency to purchase on the buyer's behalf) but the buyer will not be able to transfer the purchased item to his/her account until some trust period has passed.

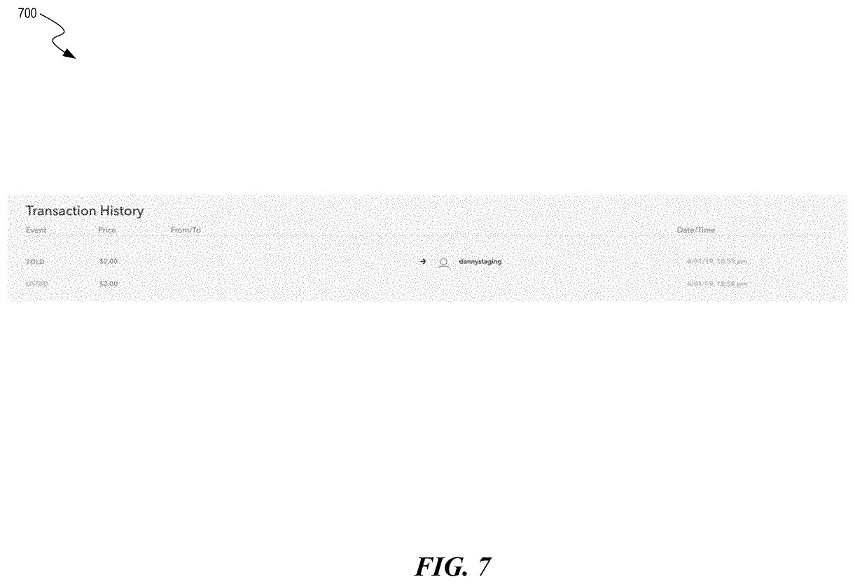

In several embodiments, instead of immediately transferring a purchased blockchain-based item to a buyer's electronic wallet, a system holds the item good in “custody” for the buyer until the buyer is ready to transfer it to his/her own account. The item can either be minted immediately or minted at the time the transfer is requested. One of the benefits of holding the item in custody is that the buyer does not need an electronic wallet at the time of purchase, only when he/she wants to claim the item. FIG. 6 is a display diagram illustrating an example user interface 600 for transferring a blockchain-based item to a buyer's electronic wallet according to various implementations. The buyer can select a blockchain-based item 605 for transfer to a selected electronic wallet identified by a unique address 610 via control 615. FIG. 7 is a display diagram illustrating an example user interface 700 displaying transaction history of a blockchain-based item according to various implementations. The system enables a buyer, seller, or any other authorized user to view one or more details of a blockchain-based item's transaction history. In several embodiments, the system imposes fees on either the buyer or seller or both for a variety of services (e.g., match making, currency conversion, etc.).

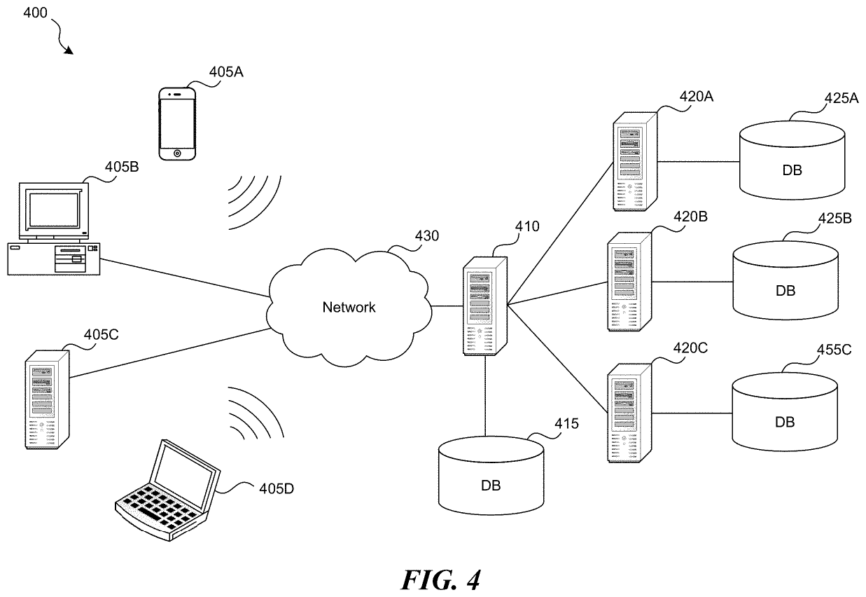

FIG. 4 is a system diagram illustrating an example of a computing environment in which the fiat to blockchain-based items system operates in some embodiments. In some implementations, environment 400 includes one or more client computing devices 405A-D, examples of which can include computer system 100. Client computing devices 405 operate in a networked environment using logical connections 410 through network 430 to one or more remote computers, such as a server computing device.

In some implementations, server 410 is an edge server which receives client requests and coordinates fulfillment of those requests through other servers, such as servers 420A-C. In some implementations, server computing devices 410 and 420 comprise computing systems, such as computer system 100. Though each server computing device 410 and 420 is displayed logically as a single server, server computing devices can each be a distributed computing environment encompassing multiple computing devices located at the same or at geographically disparate physical locations. In some implementations, each server 420 corresponds to a group of servers.

Client computing devices 405 and server computing devices 410 and 420 can each act as a server or client to other server/client devices. In some implementations, servers (410, 420A-C) connect to a corresponding database (415, 425A-C). As discussed above, each server 420 can correspond to a group of servers, and each of these servers can share a database or can have their own database. Databases 415 and 425 warehouse (e.g., store) information such as user data (e.g., user identifiers, user profiles, etc.), good/asset data (e.g., identifier, name, description, price, quantity, auction amount, etc.), cryptocurrency addresses, fiat-to-cryptocurrency and cryptocurrency-to-fiat exchange rates, etc. Though databases 415 and 425 are displayed logically as single units, databases 415 and 425 can each be a distributed computing environment encompassing multiple computing devices, can be located within their corresponding server, or can be located at the same or at geographically disparate physical locations.

Network 430 can be a local area network (LAN) or a wide area network (WAN), but can also be other wired or wireless networks. In some implementations, network 430 is the Internet or some other public or private network. Client computing devices 405 are connected to network 430 through a network interface, such as by wired or wireless communication. While the connections between server 410 and servers 420 are shown as separate connections, these connections can be any kind of local, wide area, wired, or wireless network, including network 430 or a separate public or private network.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples; alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology can include not only additional elements to those implementations noted above, but also can include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system can vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects can likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

We claim:

1. A fiat to blockchain-based items system for enabling transfer of rights involving blockchain-based items using fiat currency, the system comprising at least one non-transitory computer-readable medium having instructions stored thereon, which when executed by one or more processors of the system cause the system to:
receive a request to list a blockchain-based item for sale on behalf of a seller,
wherein the received request to list the blockchain-based item for sale comprises descriptive information about the blockchain-based item and a listing price of the blockchain-based item represented in terms of a fiat currency, and
wherein the blockchain-based item is associated with at least one right;
receive a request to purchase the at least one right in the blockchain-based item for sale from a buyer,
wherein the request to purchase the at least one right in the blockchain-based item listed for sale comprises a purchase price of the listed blockchain-based item,
wherein the purchase price of the listed blockchain-based item is represented in the fiat currency, and
wherein the purchase price of the blockchain-based item is based on the listing price of the blockchain-based item;
debit an account that holds funds represented in the fiat currency by the purchase price represented in the fiat currency;
compute a cryptocurrency amount represented in a cryptocurrency using the purchase price represented in the fiat currency;
credit the computed cryptocurrency amount to an account associated with the seller as payment for the blockchain-based item listed for sale; and
transfer the purchased at least one right in the blockchain-based item to an electronic wallet associated with the buyer.

2. The fiat to blockchain-based items system of claim 1,
wherein the at least one right in the blockchain-based item listed for sale comprises a right to own the blockchain-based item by the buyer,
a right to trade the blockchain-based item by the buyer with another user,
a right to transfer ownership of the blockchain-based item to another user,
a right to grant one or more rights to another user in the blockchain-based item,
a right to license one or more rights to another user in the blockchain-based item,
or any combination thereof.

3. The fiat to blockchain-based items system of claim 1,
wherein the at least one right in the blockchain-based item listed for sale is associated with a validity time period for which the at least one right is granted to the buyer, and
wherein at the end of the validity time period, the at least one right in the blockchain-based item is revoked.

4. The fiat to blockchain-based items system of claim 1,
wherein the account that holds funds represented in the fiat currency is a selected reserve account that is pre-funded to hold funds represented in the cryptocurrency, and
wherein the instructions when executed by one or more processors of the system further cause the system to:
compute a reserve amount by which to pre-fund the selected reserve account based on historical purchases of blockchain-based items, and
wherein the request to purchase the at least one right in the blockchain-based item listed for sale comprises information identifying the account that holds funds represented in the fiat currency.

5. The fiat to blockchain-based items system of claim 1,
wherein the account that holds funds represented in the fiat currency is a selected reserve account that is pre-funded to hold funds represented in the cryptocurrency, and
wherein the instructions when executed by one or more processors of the system further cause the system to:
compute a reserve amount by which to pre-fund the selected reserve account based on historical purchases of blockchain-based items, and
wherein the selected reserve account is associated with a digital currency exchange.

6. The fiat to blockchain-based items system of claim 1,
wherein the account that holds funds represented in the fiat currency is a selected reserve account that is pre-funded to hold funds represented in the cryptocurrency, and
wherein the instructions when executed by one or more processors of the system further cause the system to:
compute a reserve amount by which to pre-fund the selected reserve account based on historical purchases of blockchain-based items, and
wherein the fiat to blockchain-based items system maintains multiple reserve accounts each holding funds represented in different cryptocurrencies, and
wherein the fiat to blockchain-based items system selects the selected reserve account from the multiple reserve accounts based on:
the cryptocurrency,
a type of the buyer,
a location of the buyer,
a location of the account that holds funds represented in the fiat currency,
a location of the seller,
a type of the seller,
a location of the account associated with the seller,
a type of the blockchain-based item listed for sale,
a location of the blockchain-based item listed for sale,
the listing price of the blockchain-based item,
the purchase price of the blockchain-based item, or any combination thereof.

7. The fiat to blockchain-based items system of claim 1,
wherein the account that holds funds represented in the fiat currency is a selected reserve account that is pre-funded to hold funds represented in the cryptocurrency, and
wherein the instructions when executed by one or more processors of the system further cause the system to:
compute a reserve amount by which to pre-fund the selected reserve account based on historical purchases of blockchain-based items, and
wherein the purchase price of the blockchain-based item is greater than the listing price of the blockchain-based item, or less than the listing price of the blockchain-based item, or equal to the listing price of the blockchain-based item.

8. The fiat to blockchain-based items system of claim 1,
wherein the account that holds funds represented in the fiat currency is a selected reserve account that is pre-funded to hold funds represented in the cryptocurrency, and
wherein the instructions when executed by one or more processors of the system further cause the system to:
compute a reserve amount by which to pre-fund the selected reserve account based on historical purchases of blockchain-based items.

9. The fiat to blockchain-based items system of claim 1, wherein the instructions when executed by one or more processors of the system further cause the system to purchase the computed cryptocurrency amount from a digital currency exchange prior to crediting the computed cryptocurrency amount to the account associated with the seller.

10. The fiat to blockchain-based items system of claim 1, wherein the instructions when executed by one or more processors of the system further cause the system to:
upon determining that the buyer does not have an associated electronic wallet, provision the electronic wallet for the buyer prior to transferring the purchased at least one right in the blockchain-based item.

11. The fiat to blockchain-based items system of claim 1, wherein the instructions when executed by one or more processors of the system further cause the system to:
record a transaction representing a transfer of the at least one right in the blockchain-based item from the buyer to the seller on a blockchain, and
wherein the transaction is recorded using a smart contract.

12. The fiat to blockchain-based items system of claim 1, wherein the instructions when executed by one or more processors of the system further cause the system to:
record a transaction representing a transfer of the at least one right in the blockchain-based item from the buyer to the seller on a blockchain.

13. The fiat to blockchain-based items system of claim 1, wherein the request to purchase the at least one right in the blockchain-based item listed for sale further comprises a cryptocurrency address of the electronic wallet associated with the buyer.

14. The fiat to blockchain-based items system of claim 1,
wherein the account that holds funds represented in the fiat currency is a credit card account,
a PayPal account, a bank account,
a points account,
a mileage account,
an Apple Pay account,
or a Google Wallet account.

15. The fiat to blockchain-based items system of claim 1, wherein the buyer selects among multiple fiat currency accounts to select the account that holds funds represented in the fiat currency.

16. The fiat to blockchain-based items system of claim 1,
wherein the fiat to blockchain-based items system purchases the blockchain-based item for sale, at a time prior to receiving the request to purchase at least one right in the blockchain-based item for sale from a buyer, by transferring the at least one right in the blockchain-based item to an electronic wallet associated with the fiat to blockchain-based items system, and
wherein the purchased at least one right in the blockchain-based item is transferred from the electronic wallet associated with the fiat to blockchain-based items system to the electronic wallet associated with the buyer.

17. The fiat to blockchain-based items system of claim 1,
wherein the purchased at least one right in the blockchain-based item is transferred to the electronic wallet associated with the buyer upon receipt of a request to transfer the at least one right, and
wherein the blockchain-based good is minted after receiving the request to transfer the purchased at least one right in the blockchain-based item.

18. The fiat to blockchain-based items system of claim 1,
wherein the purchased at least one right in the blockchain-based item is transferred to the electronic wallet associated with the buyer upon expiration of a trust period, and
wherein the fiat to blockchain-based items system holds the purchased at least one right in the blockchain-based item in a holding electronic wallet of the fiat to blockchain-based items system until the transfer is complete.

19. A computer-implemented method for transferring rights involving blockchain-based items using fiat currency, the method comprising:
receiving a request to post a blockchain-based item for sale on behalf of a seller,
wherein the received request to post the blockchain-based item for sale includes descriptive information about the blockchain-based item and a posting price of the blockchain-based item represented in terms of a fiat currency;
receive a request to purchase at least one right in the blockchain-based item for sale from a buyer,
wherein the request to purchase the at least one right in the blockchain-based item posted for sale includes information identifying an account that holds funds represented in the fiat currency and a purchase price of the posted blockchain-based item represented in the fiat currency;
debiting a selected reserve account by the purchase price represented in the fiat currency, wherein the selected reserve account is pre-funded to hold funds represented in the cryptocurrency;
computing a cryptocurrency amount represented in a cryptocurrency using the purchase price represented in the fiat currency;
crediting the computed cryptocurrency amount to an account associated with the seller as payment for the blockchain-based item posted for sale; and
transferring the purchased at least one right in the blockchain-based item to an electronic wallet associated with the buyer.

20. At least one non-transitory, computer-readable medium carrying instructions, which when executed by at least one data processor, performs operations for transferring rights involving blockchain-based items using fiat currency, the operations comprising:
receiving a request to list a blockchain-based item for sale on behalf of a seller,
wherein the received request to list the blockchain-based item for sale comprises descriptive information about the blockchain-based item and a listing price of the blockchain-based item represented in terms of a fiat currency;
receiving a request to purchase at least one right in the blockchain-based item for sale from a buyer,
wherein the request to purchase the at least one right in the blockchain-based item listed for sale comprises a purchase price of the listed blockchain-based item, and
wherein the purchase price of the listed blockchain-based item is represented in the fiat currency;
determining or receiving a cryptocurrency amount represented in a cryptocurrency using the purchase price represented in the fiat currency;
causing to be credited the computed cryptocurrency amount to an account associated with the seller as payment for the blockchain-based item listed for sale; and
causing to be transferred the purchased at least one right in the blockchain-based item to an electronic wallet.
